(19) United States
(12) Patent Application Publication
(10) Pub. No.: US 2024/0402453 A1
(43) Pub. Date: Dec. 5, 2024

(54) LOCAL CONVERGENCE POINT TERMINAL DEVICES

(71) Applicant: CORNING RESEARCH & DEVELOPMENT CORPORATION, CORNING, NY (US)

(72) Inventors: Grant A Gildehaus, Matthews, NC (US); William Julius McPhil Giraud, Azle, TX (US); Lingling Hu, Fort Worth, TX (US)

(21) Appl. No.: 18/204,057

(22) Filed: May 31, 2023

(51) Int. Cl. G02B 6/44

(52) U.S. Cl. CPC G02B 6/4471

(57) ABSTRACT

In one embodiment, a local convergence point terminal includes a shell including a cavity, an input connection port including a port opening, a plurality of output connection ports including a port opening extending from the outer surface of the shell into the cavity, an input cable including a first fiber bundle having a plurality of input optical fibers, where the input cable is at least partially disposed within the input connection port, and a plurality of splitter assemblies within the cavity, each splitter assembly including an optical splitter, a splitter input optical fiber and a plurality of splitter output optical fibers, where a number of splitter optical fibers for each splitter assembly is a multiple of a number of input optical fibers of the input cable such that each plurality of splitter output optical fibers is routed to an individual output connection port.

### FIELD

The present disclosure is directed to convergence point terminal devices and, more particularly, to compact convergence point terminal devices for providing optical telecommunication service to a plurality of subscribers.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G and the like. As optical fiber extended deeper into communication networks the need for making robust optical connections in outdoor applications in a quick and easy manner was apparent.

Fiber to the premises (FTTP) is the installation of optical fiber direct to individual buildings such as single-family units, multi-dwelling units, and businesses to provide high-speed broadband access. FTTP dramatically increases connection speeds and reliability for broadband networks compared to legacy copper infrastructure. However, present fiber distribution hub (FDH) cabinets are large and bulky, particularly due to the number of optical connections that are required. Further, present FDH cabinets have significant insertion losses at least partially due to the large number of internal optical connections.

Accordingly, a need exists to provide smaller and more efficient devices to distribute optical fibers to individual subscribers of an optical fiber communication network.

### SUMMARY

The present disclosure is directed to local convergence point terminals for deploying optical fiber in a broadband network. The local convergence point terminals described herein have low insertion loss and are compact in size, making them ideal for use in many different settings, including rural areas.

In one embodiment, a local convergence point terminal includes a shell includes a cavity, an input connection port includes a port opening extending from an outer surface of the shell into the cavity, a plurality of output connection ports includes a port opening extending from the outer surface of the shell into the cavity, an input cable includes a first fiber bundle having a plurality of input optical fibers, where the input cable is at least partially disposed within the input connection port, and a plurality of splitter assemblies within the cavity, each splitter assembly includes an optical splitter, a splitter input optical fiber and a plurality of splitter output optical fibers, where a number of splitter optical fibers for each splitter assembly is a multiple of a number of input optical fibers of the input cable such that each plurality of splitter output optical fibers is routed to an individual output connection port of the plurality of connection ports.

In another embodiment, a local convergence point terminal includes a shell includes a cavity, an input connection port includes a port opening extending from an outer surface of the shell into the cavity, and a plurality of output connection ports includes a port opening extending from the outer surface of the shell into the cavity, where the input connection port and the plurality of output connection ports are arranged in an array at an edge of the shell. The local convergence point terminal also includes an input cable includes a first fiber bundle, where the input cable passes through the input connection port, and the first fiber bundle includes a plurality of optical fibers, and a plurality of splitter assemblies within the cavity, each splitter assembly includes an optical splitter, a splitter input optical fiber and a plurality of splitter output optical fibers, where the splitter input optical fibers of the plurality of splitter assemblies are optically coupled to the plurality of optical fibers of the first fiber bundle, and the plurality of splitter output optical fibers of each splitter assembly passes through the plurality of output connection ports.

In another embodiment, a local convergence point terminal includes a shell includes a cavity, an input connection port includes a port opening extending from an outer surface of the shell into the cavity, and a plurality of output connection ports includes a port opening extending from the outer surface of the shell into the cavity, where the input connection port and the plurality of output connection ports are arranged in an array at an edge of the shell. The local convergence point terminal also includes a plurality of multi-fiber connectors positioned within the plurality of output connection ports. The local convergence point terminal also includes an input cable includes a first fiber bundle, where the input cable passes through the input connection port, and the first fiber bundle includes a plurality of optical fibers, a plurality of splitter assemblies within the cavity, each splitter assembly includes an optical splitter, a splitter input optical fiber and a plurality of splitter output optical fibers, where the splitter input optical fibers of the plurality of splitter assemblies are optically coupled to the plurality of optical fibers of the first fiber bundle, and the plurality of splitter output optical fibers of each splitter assembly is terminated at the plurality of multi-fiber connectors in the plurality of output connection ports.

In another embodiment, a local convergence point terminal includes a shell includes a cavity, an input connection port includes a port opening extending from an outer surface of the shell into the cavity, and a plurality of output connection ports includes a port opening extending from the outer surface of the shell into the cavity, where the input connection port and the plurality of output connection ports are arranged in an array at an edge of the shell. The local convergence point terminal also includes a plurality of multi-fiber connectors positioned within the input connection port and the plurality of output connection ports. The local convergence point terminal also includes a plurality of splitter assemblies within the cavity, each splitter assembly includes an optical splitter, a splitter input optical fiber and a plurality of splitter output optical fibers, where the splitter input optical fibers of the plurality of splitter assemblies are terminated at an individual multi-fiber connector at the input connection port, and the plurality of splitter output optical fibers of each splitter assembly at terminated at the plurality of multi-fiber connectors in the plurality of output connection ports.

In another embodiment, a communication network includes a local convergence point terminal includes a shell includes a cavity, an input connection port includes a port opening extending from an outer surface of the shell into the cavity, a plurality of output connection ports includes a port opening extending from the outer surface of the shell into the cavity, an input cable includes a first fiber bundle having a plurality of input optical fibers, where the input cable is at least partially disposed within the input connection port, and a plurality of splitter assemblies within the cavity, each splitter assembly includes an optical splitter, a splitter input optical fiber and a plurality of splitter output optical fibers, where a number of splitter optical fibers for each splitter assembly is a multiple of a number of input optical fibers of the input cable such that each plurality of splitter output optical fibers is routed to an individual output connection port of the plurality of connection ports. The communication network also includes one or more drop terminals includes a drop terminal input port and a plurality of drop terminal output ports. The communication network also includes one or more drop terminal input cables coupled to one or more output connections ports of the plurality of connection ports at a first end and coupled to the drop terminal input port of the one or more drop terminals.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure, and are incorporated into and constitute a part of this specification. The drawings illustrate various embodiments and together with the description serve to explain the principles and operation.

### BRIEF DESCRIPTION OF THE FIGURES

FIG. 1 illustrates a prior art fiber distribution hub.

FIG. 2 illustrates an example broadband network comprising local convergence point terminals according to one or more embodiments described and illustrated herein.

FIG. 3 illustrates an example local convergence point terminal according to one or more embodiments described and illustrated herein.

FIG. 4 illustrates internal components of an all-ribbon local convergence point terminal according to one or more embodiments described and illustrated herein.

FIG. 5 illustrates internal components of a hybrid local convergence point terminal according to one or more embodiments described and illustrated herein.

FIG. 6 illustrates internal components of an example fully connectorized local convergence point terminal according to one or more embodiments described and illustrated herein.

### DETAILED DESCRIPTION

Reference will now be made in detail to the embodiments of the disclosure, examples of which are illustrated in the accompanying drawings. Whenever possible, like reference numbers will be used to refer to like components or parts.

Presently, broadband access optical networks are beginning to be deployed in rural communities. These communities tend to be more widely distributed as compared cities and towns, which increases both the cost and insertion loss of the system due to the long-distance connection. Insertion loss is the amount of energy that a signal loses as it travels along a cable link. Therefore, it becomes even more important to design systems that are less expensive and have better insertion loss performance than current FDH cabinets, which tend to be large, bulky and inefficient (i.e., have large and undesirable insertion losses).

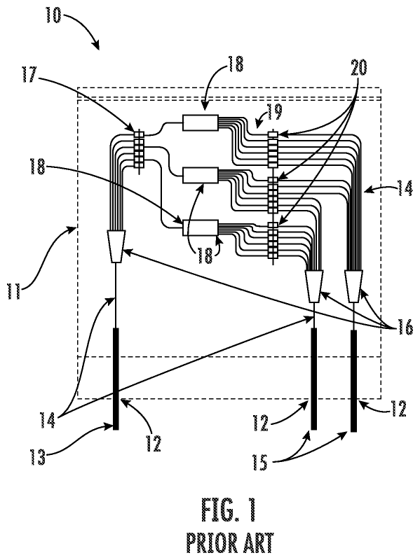

FIG. 1 illustrates an example FDH 10. The FDH 10 has a cabinet 11 in which an optical cable 13 passes through an input opening 12. The optical cable 13 has a plurality of optical fibers 14 (e.g., twelve optical fibers) that are fanned out by a ribbon fanout 16 and terminated by connectors 17 that connect them to an input leg of a splitter assembly 18, which splits the optical signal in the input leg into a plurality of split optical signals that propagate into output legs 19 of the splitter assembly 18. Each splitter output leg 19 is coupled by way of output connectors 20 to an optical fiber 14 of a distribution optical cable 15 that is fanned out by a ribbon fanout 16. The distribution optical cables 15 are routed toward subscribers. Typical cabinets 11 for the FDH 10 are large and bulky with doors or access panels that can be opened or removed for accessing the interior of the cabinet 11. Consequently, the FDH 10 typically requires a dedicated mounting location for the cabinet 11 that requires a significant footprint.

The many ribbon fanouts 16 and mechanical connectors 17, 20 included within the FDH 10 cabinet 11 makes it a large and bulky device that is both cumbersome to install and also may be unsightly. Further, the interior of the cabinet 11 may become cluttered with cables tangled and difficult to trace, which further complicates access along with any moves, adds or changes to the optical network and the like.

Embodiments of the present disclosure simplify the design and reduce the cost of fiber distribution in FTTP networks, and allow for a distributed network ideal for rural communities or the like.

Recently in data centers the use of Base-8 connectivity has become evident. This is due to the types of transceivers that switch, server and storage makers use in their equipment. As a greater number of 40G and 100G circuits are deployed which utilize eight-fiber transceivers, the benefits of matching the fiber count in the multi-fiber connector backbone connectivity with the fiber count of the transceiver tends to outweigh the density benefit of Base-12 connectivity.

Due to the simplified nature of the proposed devices using the eight-fiber ribbons already attached to current splitter devices, the insertion loss of embodiments of the present disclosure is smaller due to the reduction of mated connections when compared to current FDH cabinets. Embodiments of the present disclosure are directed to new devices referred to herein as local convergence point terminals. As described in more detail below, the local convergence point terminals may be manufactured in different configurations. An all-ribbon-splice configuration which gives the best performance but requires a higher level of skill to deploy due to the splicing that is used on the drops. A hybrid configuration is a device where only the input cable is spliced and the drops are multi-fiber connectors. Lastly, and all-multi-fiber-connector configuration where inputs and outputs are connectorized is possible.

The local convergence point terminals take advantage of the number of optical fibers that are provided as an input to the device, thereby eliminating fanouts and splitters that are found within the cabinet of traditional FDHs. Particularly, the local convergence point terminals described herein provide a number of splitter optical fibers for each splitter assembly that is a multiple of a number of input optical fibers of the input cable. In this manner, the splitter output optical fibers of each splitter is routed to an individual output connection port.

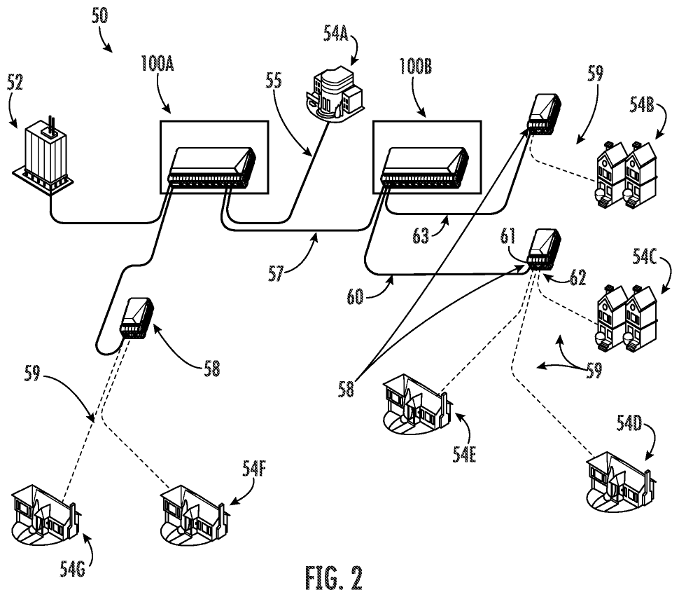

FIG. 2 illustrates an example network design using local convergence point terminals 100A and 100B along with multiport drop terminals 58 to connect subscribers to a communication network 50. A central office 52 providing a data center including switches, servers and other devices is coupled to a first local convergence point terminal 100A by an input optical cable that is provided to a input of the first local convergence point terminal 100A. A first output cable is provided to a multiport drop terminal 58, the outputs of which are provided to subscribers 54G and 54F by subscriber drop cables.

A first pass-through cable 55 exits the first local convergence point terminal 100A to provide connection to a large subscriber 54A, such as a business. A second pass-through cable 57 exits the first local convergence point terminal 100A and is provided to an input of a second local convergence point terminal 100B. First and second drop terminal input cables 60, 63 are coupled to outputs of the second local convergence point terminal 100B, are further coupled to drop terminal input ports 61 of two other drop terminals 58. Subscriber drop cables 59 are coupled to drop terminal output ports 62 of the drop terminals 58 and are provided to subscribers 54B-54E.

Various embodiments of fiber optic local convergence point terminals are described in detail below.

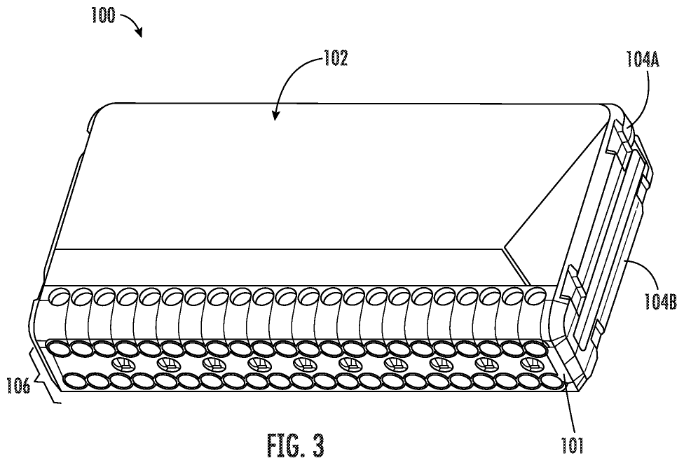

Referring now to FIG. 3, a non-limiting example of a local convergence point terminal 100 is illustrated. The illustrated local convergence point terminal 100 comprises a shell 102 defining an interior cavity in which the internal components are disposed. The shell 102 may be defined by two half-shells, such as an upper shell 104A and a lower shell 14B, for example. The shell 102 defines an edge 101 having an array of connection ports 106 that are defined by an opening extending into a cavity of the local convergence point terminal 100. The connection ports 106 may be configured for receiving external optical connectors or one or more connection ports for receiving fiber optic cables through an edge 101 of the local convergence point terminal 100 and into the cavity of the local convergence point terminal 100. The connection ports 106 may include any suitable mating mechanism or geometry for securing the external connector to the terminal or have any suitable construction for receiving a fiber optic cable into the cavity of the terminal.

The local convergence point terminals 100 disclosed allow a compact footprint and light weight for the device compared with the FDH 10 that requires a large and heavy cabinet 11. One reason for the compact footprint is that the connection ports 106 of the local convergence point terminals 100 may have a portion defined by shell 102. Further, the optical connections for the local convergence point terminals 100 are made from the external side of the shell 102. Whereas, cabinet 11 of FDH 10 can be very large with doors that open for access into the cabinet 11 so that the optical connections and cables may be accessed from inside the cabinet. By way of explanation, cabinet 11 of suitable size for the FDH 10 can be one meter or more tall with a suitably large width and length footprint that may require a dedicated pad or mount for installation.

On the other hand, the connection ports 106 may be disposed on a common exterior side of the shell 102 for local convergence point terminals 100, but other suitable arrangements are possible as well. Besides the smaller size, the local convergence point terminals 100 disclosed are also advantageous for providing plug and play connectivity once installed without the need to enter the cavity of the device like the FDH 10 of FIG. 1. By way of example and not limitation, the local convergence point terminals disclosed may have dimensions defined in millimeters such as a width of 400 millimeters or less, a height of 100 millimeters or less, and a depth of 200 millimeters or less. Of course, the concepts disclosed for local convergence point terminals may have other suitable sizes as well.

Although the array of connection ports 106 is configured as having two rows, embodiments are not limited thereto. A single row or more than two rows of connection ports 106 may be provided as desired.

In some embodiments, the connection ports 106 of the local convergence point terminal 100 may have a push-and-retain connection without the use of threaded coupling nuts or quick turn bayonets for securing the external connectors. This allows for local convergence point terminals with connection ports that are closely spaced together and may result in relatively small local convergence point terminals since the room needed for turning a threaded coupling nut or bayonet is not necessary. The compact form-factors may allow the placement of the terminals in tight spaces in indoor, outdoor, buried, aerial, industrial or other applications while providing at least one connection port that is advantageous for a robust and reliable optical connection in a removable and replaceable manner. The disclosed local convergence point terminals may also be aesthetically pleasing and provide organization for the optical connectors in manner that the prior art FDH cabinets cannot provide. However, the external fiber optic connectors may be secured to the terminal using conventional structures such as threads, bayonets or other suitable mating geometry for attaching to the connector ports of the terminal.

Local convergence point terminals disclosed herein may also have a dense spacing of connection ports for receiving external optical connectors if desired or not. The local convergence point devices disclosed herein advantageously allow a relatively dense and organized array of connection ports in a relatively small form-factor while still being rugged for demanding environments; however local convergence point terminals of any size or shape are possible using the concepts disclosed. As optical networks increase densifications and space is at a premium, the robust and small-form factors for devices such as local convergence point terminals disclosed and depicted herein becomes increasingly desirable for network operators.

As stated above, embodiments of the present disclosure leverage the use of 8-fiber ribbons that are already attached to splitter devices and package them into a small-footprint local convergence point terminal. The embodiments described herein provide significant reduction of material cost, size, and signal loss over conventional fiber distribution hub cabinets. In addition, incorporation of multi-fiber connectors, such as MTP® connectors, at the output as an optional reduces the skill level needed and speed up the installation process, as described in more detail below.

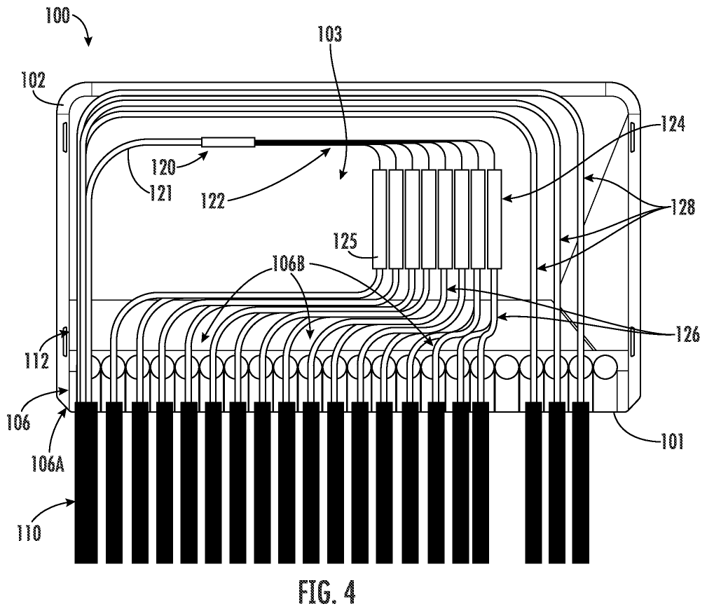

FIG. 4 illustrates interior components within a cavity 103 of a non-limiting example local convergence point terminal 100. A plurality of ports 106 are provided at the edge 101 of the shell 102 of the local convergence point terminal 100. The plurality of ports 106 includes an input connection port 106A having a port opening extending from the outer surface of the shell 102 into the cavity 103. In the illustrated embodiment, an input cable 110 passes through the opening of the input connection port 106A without the mating of connectors. Providing the input cable 110 directly through the input connection port 106A lowers insertion loss that would be present at a mated connection at the input connection port 106A.

The input cable 110 comprises an outer jacket that encloses a plurality of plurality of fiber bundle 112, with each fiber ribbon comprising eight individual optical fibers. In other embodiments, each fiber ribbon may include more or fewer than eight individual optical fibers. It is noted that although the fiber bundles described herein are also referred to as fiber ribbons, embodiments are not limited thereto. For example, the optical fibers described herein may be bundled or otherwise formed in an array by a method other than ribbonization.

The plurality of fiber ribbons 112 comprises at least one first fiber ribbon 121 as an input fiber ribbon and a plurality of pass-through fiber ribbons 128. The plurality of pass-through fiber ribbons 128 pass directly through a sub-set of the plurality of output ports 106B of the shell 102 without mated connectors. Each pass-through fiber ribbon 128 may be jacketed at the port opening of the sub-set of the plurality of output ports 106B. This sub-set of the plurality of output ports 106B are pass-through output ports. It is noted that in the illustrated embodiment the input connection port 106A is positioned at a first end of the array, and the one or more one pass-through output connection ports are positioned at a second end of the array that is opposite from the first end of the array. As described above, the pass-through fiber ribbons 128 may be terminated at other optical devices such as additional local convergence point terminals or fiber distribution hubs downstream from the illustrated local convergence point terminal 100.

The local convergence point terminal 100 further comprises a plurality of splitter assemblies 124. In the illustrated embodiment, there are eight splitter assemblies 124 for the eight input optical fibers of the first fiber ribbon 121. Each splitter assembly comprises a splitter input optical fiber 122 operable to receive an optical signal, an optical splitter 125 configured to split the optical signal into a plurality of split optical signals, and a plurality of splitter output optical fibers 126 operable to receive the plurality of split optical signals. In the illustrated embodiment, the optical splitter splits the optical signal into eight split optical signals that are propagated into eight splitter output optical fibers 126.

The input optical fibers of the first fiber ribbon 121 are optically coupled to the splitter input optical fibers 122 such as, without limitation, a splice 120 (e.g., a fusion splice or a mechanical splice). The splice 120 provides a low-loss optical coupling between the first fiber ribbon 121 and the splitter input optical fibers 122.

In the illustrated embodiment, the plurality of splitter output optical fibers 126 of each splitter assembly 124 may be ribbonized as a split fiber ribbon. The plurality of splitter fiber ribbons 126 of the plurality of splitter assemblies 124 pass through the port openings through a sub-set of the plurality of output ports 106B. In some embodiments, each split fiber ribbon 126 may be jacketed at the port opening of the sub-set of the plurality of output ports 106B. The split fiber ribbons 126 may be routed to subscribers such that one or more individual output fibers 126 may be routed to individual subscribers.

Providing the optical splitter assemblies 124 within the shell without internal optical connectors and fanouts provides a device having both a compact footprint and low insertion loss.

In the embodiment of FIG. 4, the input cable 110, the plurality of split fiber ribbons 126, and the one or more pass-through fiber ribbons 128 pass directly through their respective port openings without mechanical connections between mated optical connectors. In other embodiments, one or more optical connectors may be provided at one or more ports of the local convergence point terminal.

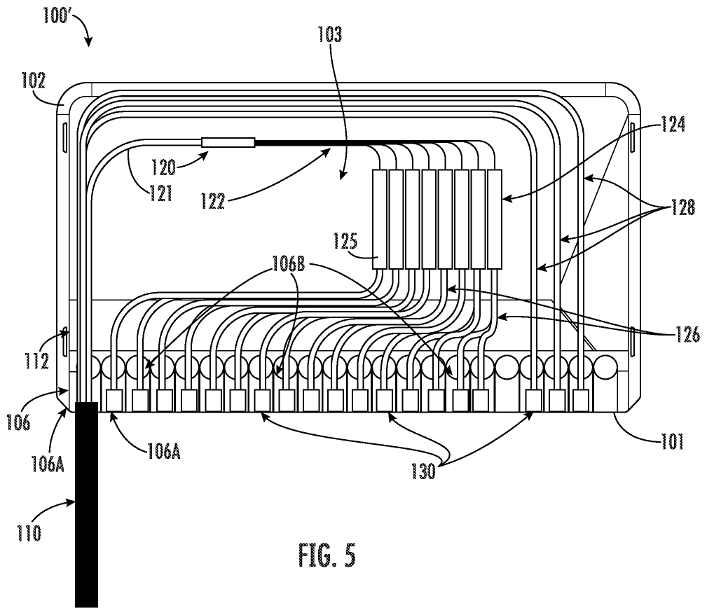

FIG. 5 illustrates an example hybrid local convergence point terminal 100′ wherein only the input cable 110 passes through the port opening of the input connection port 106A. The plurality of output ports 106B have plurality of multi-fiber connectors 130 (e.g., MTP® connectors) disposed therein. The other features of the local convergence point terminal 100′ of FIG. 5 are the same as those of the local convergence point terminal 100 of FIG. 4. For example, the input cable 110 passes through the input port 106A without an optical connector.

The splitter optical fibers of the splitter fiber ribbons 126 of the splitter assemblies 124 are terminated at the multi-fiber connectors 130. Similarly, the pass-through fiber ribbons 128 are terminated at the multi-fiber connectors 130. Mating optical connectors are configured to mate with the multi-fiber connectors 130 to connect the splitter fiber ribbons 126 and the pass-through fiber ribbons 128 to subscribers.

Because mated connections are made at the multi-fiber connectors 130, the insertion loss of the hybrid local convergence point terminal 100′ may be larger than that of the fully ribbonized local convergence point terminal 100 of FIG. 4. However, the hybrid local convergence point terminal 100′ may be more flexible as connections may be added and removed easily in the field.

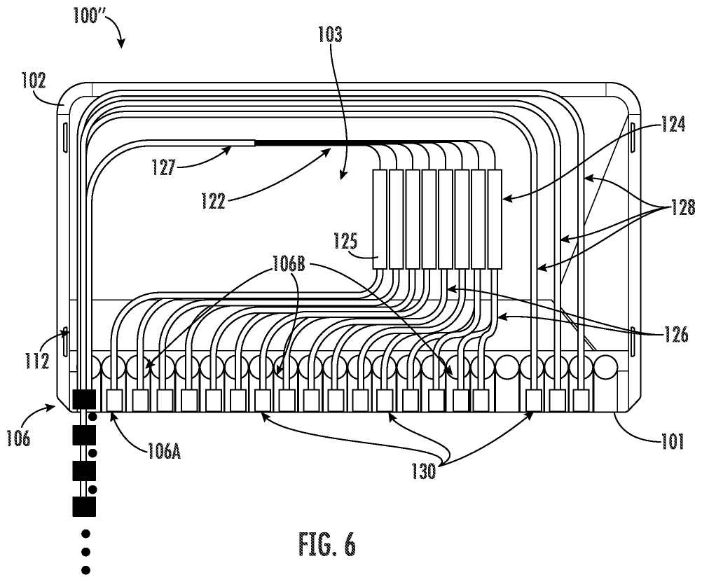

FIG. 6 illustrates a local convergence point terminal 100″ that is fully connectorized. Unlike the local convergence point terminal 100 of FIG. 4, the local convergence point terminal 100″ does not have a splice or other optical coupling between the input port 106A and the plurality of splitter assemblies 124. Rather, the splitter input optical fibers 122 are ribbonized (as indicated by reference number 127 and directly coupled to an input multi-fiber connector 132 at the edge 101 of the shell 102. Like the local convergence point terminal 100′ of FIG. 5, the splitter optical fibers of the splitter fiber ribbons 126 of the splitter assemblies 124 are terminated at the multi-fiber connectors 130. The pass-through fiber ribbons 128 extend between output multi-fiber connectors 130 and input multi-fiber connectors 132.

Thus, the fully connectorized local convergence point terminal 100″ has no optical cables or ribbons that extend from the edge 101. The input cable, input pass-through cables, output pass-through cables and output cables to subscribers are connected to the local convergence point terminal 100″ by way of the input multi-fiber connectors 132 and the output multi-fiber connectors 130 (e.g., MTP® connectors).

Because the local convergence point terminal 100″ of FIG. 6 is fully connectorized, it may have larger insertion loss than the local convergence point terminal 100′ of FIG. 5 and the local convergence point terminal 100 of FIG. 4. However, the fully connectorized local convergence point terminal 100″ may afford the greatest flexibility.

The local convergence point terminals using the concepts disclosed herein may also be drastically smaller and compact with respect to the FDH 10 of FIG. 1 that comprises cabinet 11. Consequently, FDH 10 has a large size cabinet having access doors and relatively heavy tsuch as 20 inches

Although the disclosure has been illustrated and described herein with reference to explanatory embodiments and specific examples thereof, it will be readily apparent to those of ordinary skill in the art that other embodiments and examples can perform similar functions and/or achieve like results. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. A local convergence point terminal comprising:
a shell comprising a cavity;
an input connection port comprising a port opening extending from an outer surface of the shell into the cavity;
a plurality of output connection ports comprising a port opening extending from the outer surface of the shell into the cavity;
an input cable comprising a first fiber bundle having a plurality of input optical fibers, wherein the input cable is at least partially disposed within the input connection port, and
a plurality of splitter assemblies within the cavity, each splitter assembly comprising an optical splitter, a splitter input optical fiber and a plurality of splitter output optical fibers, wherein a number of splitter optical fibers for each splitter assembly is a multiple of a number of input optical fibers of the input cable such that each plurality of splitter output optical fibers is routed to an individual output connection port of the plurality of output connection ports.

2. The local convergence point terminal of claim 1, wherein the plurality of input optical fibers of the first fiber bundle are coupled to the splitter input optical fibers of the plurality of splitter assemblies.

3. The local convergence point terminal of claim 2, wherein the plurality of input optical fibers of the first fiber bundle is coupled to the splitter input optical fiber of the plurality of splitter assemblies by a splice.

4. The local convergence point terminal of claim 2, wherein the plurality of input optical fibers of the first fiber bundle is coupled to the splitter input optical fiber of the plurality of splitter assemblies by a connector.

5. The local convergence point terminal of claim 1, wherein the first fiber bundle is ribbonized.

6. The local convergence point terminal of claim 1, wherein the plurality of splitter output optical fibers of each splitter is ribbonized.

7. The local convergence point terminal of claim 1, wherein the first fiber bundle comprises eight input optical fibers and each plurality of splitter output optical fiber comprises eight splitter output optical fibers.

8. The local convergence point terminal of claim 1, wherein the input connection port and the plurality of output connection ports are arranged in an array at an edge of the shell.

9. The local convergence point terminal of claim 1, further comprising at least one pass-through output connection port comprising a port opening extending from the outer surface of the shell into the cavity, wherein:
the input cable further comprises at least one pass-through fiber bundle; and
the at least one pass-through fiber bundle is routed to the at least one pass-through output connection port.

10. The local convergence point terminal of claim 9, wherein the at least one pass-through fiber bundle is ribbonized.

11. A local convergence point terminal comprising:
a shell comprising a cavity;
an input connection port comprising a port opening extending from an outer surface of the shell into the cavity; and
a plurality of output connection ports comprising a port opening extending from the outer surface of the shell into the cavity, wherein the input connection port and the plurality of output connection ports are arranged in an array at an edge of the shell;
an input cable comprising a first fiber bundle, wherein:
the input cable passes through the input connection port, and
the first fiber bundle comprises a plurality of optical fibers, and
a plurality of splitter assemblies within the cavity, each splitter assembly comprising an optical splitter, a splitter input optical fiber and a plurality of splitter output optical fibers, wherein:
the splitter input optical fibers of the plurality of splitter assemblies are optically coupled to the plurality of optical fibers of the first fiber bundle, and
the plurality of splitter output optical fibers of each splitter assembly passes through the plurality of output connection ports.

12. The local convergence point terminal of claim 11, wherein the plurality of splitter assemblies comprises eight splitter assemblies.

13. The local convergence point terminal of claim 11, wherein the plurality of optical fibers of the first fiber bundle is coupled to the splitter input optical fiber of the plurality of splitter assemblies by a splice.

14. The local convergence point terminal of claim 11, wherein the plurality of optical fibers of the first fiber bundle is coupled to the splitter input optical fiber of the plurality of splitter assemblies by a connector.

15. The local convergence point terminal of claim 11, wherein a number of splitter optical fibers for each splitter assembly is a multiple of a number of input optical fibers of the input cable such that each plurality of splitter output optical fibers is routed to an individual output connection port of the plurality of output connection ports.

16. The local convergence point terminal of claim 11, wherein the plurality of splitter output optical fibers of each splitter assembly comprises eight splitter output optical fibers.

17. The local convergence point terminal of claim 11, further comprising at least one pass-through output connection port comprising a port opening extending from the outer surface of the shell into the cavity, wherein:
the input cable further comprises at least one pass-through fiber bundle; and
the at least one pass-through fiber bundle passes through the at least one pass-through output connection port.

18. The local convergence point terminal of claim 17, wherein the first fiber bundle and the at least one pass-through fiber bundle each comprise eight optical fibers.

19. The local convergence point terminal of claim 17, wherein the at least one pass-through fiber bundle is ribbonized.

20. The local convergence point terminal of claim 17, wherein:
the input connection port is positioned at a first end of the array; and
the at least one pass-through output connection port is positioned at a second end of the array that is opposite from the first end of the array.

21. The local convergence point terminal of claim 11, wherein the array comprises a single row.

22. The local convergence point terminal of claim 11, wherein the array comprises a first row and a second row.

23. A local convergence point terminal comprising:
a shell comprising a cavity;
an input connection port comprising a port opening extending from an outer surface of the shell into the cavity; and
a plurality of output connection ports comprising a port opening extending from the outer surface of the shell into the cavity, wherein the input connection port and the plurality of output connection ports are arranged in an array at an edge of the shell;
a plurality of multi-fiber connectors positioned within the plurality of output connection ports;
an input cable comprising a first fiber bundle, wherein:
the input cable passes through the input connection port, and
the first fiber bundle comprises a plurality of optical fibers,
a plurality of splitter assemblies within the cavity, each splitter assembly comprising an optical splitter, a splitter input optical fiber and a plurality of splitter output optical fibers, wherein:
the splitter input optical fibers of the plurality of splitter assemblies are optically coupled to the plurality of optical fibers of the first fiber bundle, and
the plurality of splitter output optical fibers of each splitter assembly is terminated at the plurality of multi-fiber connectors in the plurality of output connection ports.

24. The local convergence point terminal of claim 23, wherein the plurality of splitter assemblies comprises eight splitter assemblies.

25. The local convergence point terminal of claim 23, wherein the plurality of optical fibers of the first fiber bundle is coupled to the splitter input optical fiber of the plurality of splitter assemblies by a splice.

26. The local convergence point terminal of claim 23, wherein the plurality of optical fibers of the first fiber bundle is coupled to the splitter input optical fiber of the plurality of splitter assemblies by a connector.

27. The local convergence point terminal of claim 23, wherein a number of splitter optical fibers for each splitter assembly is a multiple of a number of input optical fibers of the input cable such that each plurality of splitter output optical fibers is routed to an individual output connection port of the plurality of output connection ports.

28. The local convergence point terminal of claim 23, wherein the plurality of splitter output optical fibers of each splitter assembly comprises eight splitter output optical fibers.

29. The local convergence point terminal of claim 23, further comprising at least one pass-through output connection port comprising a port opening extending from the outer surface of the shell into the cavity, wherein:
the input cable further comprises at least one pass-through fiber bundle, and
at least one multi-fiber connector of the plurality of multi-fiber connectors is disposed within the at least one pass-through output connection port, and
the at least one pass-through fiber bundle is terminated at the at least one multi-fiber connector in the at least one pass-through output connection port.

30. The local convergence point terminal of claim 29, the first fiber bundle and the at least one pass-through fiber bundle comprises eight optical fibers.

31. The local convergence point terminal of claim 29, wherein:
the input connection port is positioned at a first end of the array; and
the at least one pass-through output connection port is positioned at a second end of the array that is opposite from the first end of the array.

32. The local convergence point terminal of claim 23, wherein the array comprises a single row.

33. The local convergence point terminal of claim 23, wherein the array comprises a first row and a second row.

34. The local convergence point terminal of claim 23, wherein the plurality of multi-fiber connectors is a plurality of multi-fiber termination push-on connectors.

35. A local convergence point terminal comprising:
a shell comprising a cavity;
an input connection port comprising a port opening extending from an outer surface of the shell into the cavity; and
a plurality of output connection ports comprising a port opening extending from the outer surface of the shell into the cavity, wherein the input connection port and the plurality of output connection ports are arranged in an array at an edge of the shell;
a plurality of multi-fiber connectors positioned within the input connection port and the plurality of output connection ports;
a plurality of splitter assemblies within the cavity, each splitter assembly comprising an optical splitter, a splitter input optical fiber and a plurality of splitter output optical fibers, wherein:
the splitter input optical fibers of the plurality of splitter assemblies are terminated at an individual multi-fiber connector at the input connection port, and
the plurality of splitter output optical fibers of each splitter assembly at terminated at the plurality of multi-fiber connectors in the plurality of output connection ports.

36. The local convergence point terminal of claim 35, wherein the plurality of splitter assemblies comprises eight splitter assemblies.

37. The local convergence point terminal of claim 35, wherein a number of splitter optical fibers for each splitter assembly is a multiple of a number of input optical fibers of an input cable operable to be coupled to the input connection port such that each plurality of splitter output optical fibers is routed to an individual output connection port of the plurality of output connection ports.

38. The local convergence point terminal of claim 35, wherein the plurality of splitter output optical fibers of each splitter assembly comprises eight splitter output optical fibers.

39. The local convergence point terminal of claim 35, further comprising at least one pass-through output connection port comprising a port opening extending from the outer surface of the shell into the cavity, wherein:
at least one multi-fiber connector of the plurality of multi-fiber connectors is disposed within the at least one pass-through output connection port, and
at least one pass-through fiber bundle within the cavity is terminated at the at least one multi-fiber connector in the at least one pass-through output connection port.

40. The local convergence point terminal of claim 39, wherein the at least one pass-through fiber bundle comprises eight optical fibers.

41. The local convergence point terminal of claim 39, wherein:
the input connection port is positioned at a first end of the array; and
the at least one pass-through output connection port is positioned at a second end of the array that is opposite from the first end of the array.

42. The local convergence point terminal of claim 35, wherein the array comprises a single row.

43. The local convergence point terminal of claim 35, wherein the array comprises a first row and a second row.

44. The local convergence point terminal of claim 35, wherein the plurality of multi-fiber connectors is a plurality of multi-fiber termination push-on connectors.

45. A communication network comprising:
a local convergence point terminal comprising:
a shell comprising a cavity;
an input connection port comprising a port opening extending from an outer surface of the shell into the cavity;
a plurality of output connection ports comprising a port opening extending from the outer surface of the shell into the cavity;
an input cable comprising a first fiber bundle having a plurality of input optical fibers, wherein the input cable is at least partially disposed within the input connection port, and
a plurality of splitter assemblies within the cavity, each splitter assembly comprising an optical splitter, a splitter input optical fiber and a plurality of splitter output optical fibers, wherein a number of splitter optical fibers for each splitter assembly is a multiple of a number of input optical fibers of the input cable such that each plurality of splitter output optical fibers is routed to an individual output connection port of the plurality of output connection ports; and
one or more drop terminals comprising a drop terminal input port and a plurality of drop terminal output ports; and
one or more drop terminal input cables coupled to one or more output connections ports of the plurality of output connection ports at a first end and coupled to the drop terminal input port of the one or more drop terminals.

46. The communication network of claim 45, further comprising one or more subscriber drop cables coupled to one or more drop terminal output ports of the plurality of drop terminal output ports that are operable to be provided to a subscriber.

47. The communication network of claim 45, wherein the plurality of input optical fibers of the first fiber bundle are coupled to the splitter input optical fibers of the plurality of splitter assemblies.

48. The communication network of claim 47, wherein the plurality of input optical fibers of the first fiber bundle is coupled to the splitter input optical fiber of the plurality of splitter assemblies by a splice.

49. The communication network of claim 47, wherein the plurality of input optical fibers of the first fiber bundle is coupled to the splitter input optical fiber of the plurality of splitter assemblies by a connector.

50. The communication network of claim 45, wherein the first fiber bundle is ribbonized.

51. The communication network of claim 45, wherein the plurality of splitter output optical fibers of each splitter is ribbonized.

52. The communication network of claim 45, wherein the first fiber bundle comprises eight input optical fibers and each plurality of splitter output optical fiber comprises eight splitter output optical fibers.

53. The communication network of claim 45, wherein the input connection port and the plurality of output connection ports are arranged in an array at an edge of the shell.

54. The communication network of claim 45, further comprising at least one pass-through output connection port comprising a port opening extending from the outer surface of the shell into the cavity, wherein:
the input cable further comprises at least one pass-through fiber bundle; and
the at least one pass-through fiber bundle is routed to the at least one pass-through output connection port.

55. The communication network of claim 54, wherein the at least one pass-through fiber bundle is ribbonized.
